(19) United States
(12) Patent Application Publication
(10) Pub. No.: US 2012/0278226 A1
(43) Pub. Date: Nov. 1, 2012

(54) SYSTEMS AND METHODS FOR USING DATA METRICS FOR CREDIT SCORE ANALYSIS

(75) Inventors: Brian Kolo, Leesburg, VA (US); Thomas Rickett McGraw, Little Rock, AR (US); Dathan Gaskill, Little Rock, AR (US)

(73) Assignee: Black Oak Partners, LLC, Little Rock, AR (US)

(21) Appl. No.: 13/456,532

(22) Filed: Apr. 26, 2012

Related U.S. Application Data
(60) Provisional application No. 61/479,169, filed on Apr. 26, 2011.

(51) Int. Cl. G06Q 40/02

(52) U.S. Cl. 705/38

(57) ABSTRACT

Embodiments of the present invention may provide systems and methods for receiving a request for an individual's credit report; identifying the individual's one or more credit entries from the individual's credit report; accessing a credit model; calculating a credit score with the credit model using aspects derived from the individual's credit report; accessing a data metrics model; calculating a data metrics score for the individual's one or more credit entries; preparing a credit report combining the results of the credit score and the data metrics score; and sending the credit report.

### CROSS-REFERENCE TO RELATED APPLICATIONS

This application claims priority to U.S. Provisional Patent Application No. 61/479,169, filed Apr. 26, 2011; the content of which is incorporated herein by reference in its entirety.

This application incorporates by reference PCT Patent Application No. PCT/US2010/045917, filed Aug. 18, 2010; the content of which is incorporated herein by reference in its entirety.

### FIELD OF THE INVENTION

The present invention relates to the field of data metrics. More specifically, the present invention relates to systems and methods of using data quality and data metrics in combination with credit scores.

### BACKGROUND OF INVENTION

Credit scores represent a critical aspect of the economy as an individual's credit worthiness is often measures by their credit score.

An individual's credit score is computed by applying a credit model to a set of credit data, such as credit report data, collection data, and public record data for the individual. Credit report data is supplied by companies that lend money or offer credit, such as credit card issuers, while public record data are obtained from federal, state and county courthouses and other locations.

For example, credit grantors send their accounts receivable data each month to a Credit Reporting Agency (“CRA”). This information contains date of origination, current payment history, the loan amount, payment information, current payment information, and type of loan. If it is a credit card the credit limit, high credit and balance are provided. This is the same information that is used to create monthly billing statements from the credit grantor; they do not create separate information to send to the CRAs.

The CRAs have some data in common, but each CRA has access to unique data via proprietary relationships and deploy different proprietary data management techniques and rules to match and maintain credit information to create a consumer credit report. Because of this, the credit data for a particular individual may be somewhat different at each individual CRA.

When a credit report for a particular individual is requested from a CRA, the CRA compiles credit and public record information from its repository believed to be associated with the individual inquired upon. The party requesting the credit report may independently subscribe with the CRA to submit the credit report compiled by the CRA into credit scoring algorithm(s) maintained by the CRA or may submit the credit report obtained from the CRA into credit scoring algorithm(s) housed and maintained by the party requesting the credit report to estimate a variety of credit performance outcomes. These credit performance outcomes may include, but are not limited to, the likelihood of delinquency or bankruptcy, the propensity to revolve or generate interest/fee revenue, the likelihood to respond to credit offers, and the probability of making a payment towards a delinquent account. One credit model that is often applied by the CRAs is the FICO CLASSIC credit risk model developed by FICO. The FICO classic score is a measure of credit risk computed based on an individual's credit data from a CRA.

Risk Scoring (aka “credit risk scoring”)

Risk scoring is the process of summarizing the data on credit reports into a number. Lenders, collection agencies, landlords, insurance companies, and utility providers are examples of companies who use this number, called a “credit bureau based risk score”, to determine credit or insurance risk. The most common brand or variation of credit risk score is the FICO CLASSIC credit risk model. Many of the credit scoring systems offered by CRAs or proprietary credit scoring systems housed and maintained by parties requesting consumer credit reports are similar in nature.

The FICO score falls into a published range of 300 to 850 but most people will score between 500 and 800. A higher score equates to lower risk and a lower score equates to higher risk. A higher score often makes it easier to qualify for loans and insurance and competitive rates and terms. A lower score may cause the loan to be denied or approved with disadvantaged terms.

The FICO scoring model is actually a collection of several scoring models called “scorecards.” Scorecards are designed to evaluate and leverage credit information unique to homogenous consumer types. For example, consumers who have a bankruptcy on their credit report are scored in a scorecard designed to evaluate the risk of bankrupt consumers. Consumers who have very young credit reports are scored in a scorecard designed to evaluate the risk of consumers who don't have a long history of credit usage. The reason for segmenting consumers based upon their experience and performance with consumer credit is to ensure that the relevant credit information associated with each unique population of consumers is maximized to assess the credit risk for individuals within and across each consumer segment.

Odds to Score Relationship

The FICO score numbers have a meaning. What does a 750 mean as compared to a 700? Each of those numbers tells a story about predicted risk and that story is expressed as odds. Odds, in a credit scoring discussion, are generally determined by studying and understanding the number of consumers who are going to pay their bills on time relative to the one consumer who will not. This is an example of how the odds may change by FICO score range:

FICO 800=800 goods to every 1 bad

FICO 750=400 goods to every 1 bad

FICO 700=200 goods to every 1 bad

FICO 650=100 goods to every 1 bad

FICO 600=50 goods to every 1 bad

FICO 550=25 good to every 1 bad

FICO 500=12 goods to every 1 bad

FICO Score Breakdown

In general the FICO score “points” are broken down and awarded from 5 different categories. These are:

Payment Performance—35% of the points in a FICO score come from this category. This is where negative information is going to be evaluated. Late payments, bankruptcy, settlements, charge offs, repossessions, collections, partial payment plans, liens, foreclosures, judgments and other derogatory information can severely punish the score. Additionally, the frequency, severity and prevalence of these items are also a meaningful measurement in this category.

Debt Usage—30% of the points in the FICO score come from this category. This is where installment, revolving and open debt is going to be evaluated. While installment debt (fixed payment for a fixed number of months) is important, it takes a back seat to revolving credit card debt because it's unsecured and an elevated risk for lenders. A car can be repossessed if there is default on a car loan but items purchased on a credit card can't be repossessed. The number of accounts with a balance, aggregate and line item revolving utilization (balances divided by credit limits) and the total amount of debt is seen by this category. In fact, the revolving utilization percentage might be the most profiled aspect of the FICO scoring system in the media.

Time in File—15% of the points in a FICO score come from this category. This is where the age of the credit report AND the average age of the accounts is going to be evaluated. The age of the file is determined by taking the “date opened” from the oldest reporting account. The average age is determined by averaging all of the accounts together. For example, if a person has two accounts, one opened 5 years ago and the second opened 3 years ago then the “age” is going to be 5 and the “average age” is going to be 4. Older is better in both categories.

Account Diversity—10% of the points in a FICO score come from this category. Mortgage, auto, credit card are among the different types of accounts. Having a diverse account set is good for scores.

Search for Credit—10% of the points in a FICO score come from this category. Some people call this the “Inquiry” category because this is where credit inquiries are going to be measured.

Currently, traditional consumer credit report data offers a static, contemporaneous profile of consumer credit obligations. Today's consumer credit report offers a limited historical perspective of a consumer's credit behavior focused on timing of inquiries, account openings, account closings and historical monthly account status indicators as the only account level data element to provide insight about the volatility and direction of a consumer's repayment ability. Release of enhanced account level information, including historical credit score information, may provide additional opportunities to use data quality and data metrics in relation to credit scores. The availability of time series account level credit balance and limit information for all account types may provide additional opportunities for determining a consumer's use and ability to repay credit obligations. Needs exist for new systems and methods to use this additional information.

### SUMMARY OF INVENTION

Embodiments of the present invention may provide systems and methods for receiving a request for an individual's credit report; identifying the individual's one or more credit entries from the individual's credit report; accessing a credit model; calculating a credit score with the credit model using aspects derived from the individual's credit report; accessing a data metrics model; calculating a data metrics score for the individual's one or more credit entries; preparing a credit report combining the results of the credit score and the data metrics score; and sending the credit report.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the, invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. While these drawings only show a particular embodiment, for that embodiment they are roughly drawn to scale.

FIG. 1 shows an exemplary system for data quality and data metrics analysis in a networked computing environment.

FIG. 2 shows an exemplary server for data quality and data metrics analysis in a networked computing environment.

FIG. 3 shows an exemplary process for data quality and data metrics analysis.

### DETAILED DESCRIPTION OF THE EMBODIMENTS

Systems and methods are described for data quality and data metrics analysis. The examples described herein relate to credit scores for illustrative purposes only. The systems and methods described herein may be used for many different purposes and industries.

Although not required, the systems and methods are described in the general context of computer program instructions executed by one or more computing devices. Computing devices typically include one or more processors coupled to data storage for computer program modules and data. Key technologies include, but are not limited to, the multi-industry standards of Microsoft Operating Systems, SQL Server, .NET Framework (VB.NET, ASP.NET, AJAX.NET, etc.), Oracle database BIEE products, other e-Commerce products and computer languages. Such program modules generally include computer program instructions such as routines, programs, objects, components, etc., for execution by the at least one processor to perform particular tasks, utilize data, data structures, and/or implement particular abstract data types. While the systems, methods, and apparatus are described in the foregoing context, acts and operations described hereinafter may also be implemented in hardware.

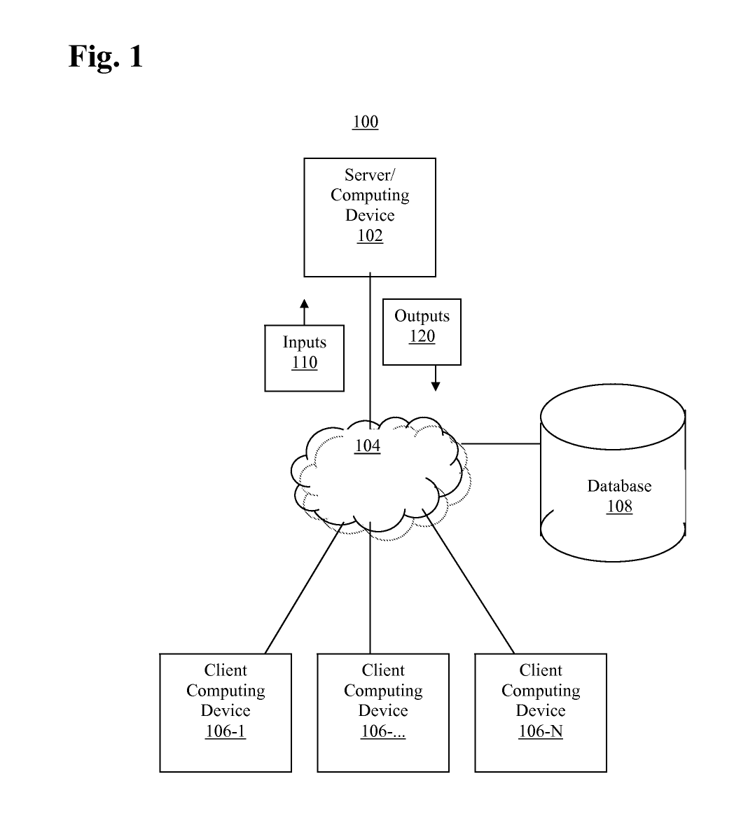

FIG. 1 shows an exemplary system 100 for data quality and data metrics analysis, according to one embodiment. In this exemplary implementation, system 100 includes server/computing device 102 operatively coupled over network 104 to one or more client computing devices 106 (e.g., 106-1 through 106-N) and one or more databases 108. Server/computing device 102 represents, for example, any one or more of a server, a general-purpose computing device such as a server, a personal computer (PC), a laptop, and/or so on. Networks 104 represent, for example, any combination of the Internet, local area network(s) such as an intranet, wide area network(s), and/or so on. Such networking environments are commonplace in offices, enterprise-wide computer networks, etc. Client computing devices 106, which may include at least one processor, represent a set of arbitrary computing devices executing application(s) that respectively send data inputs 110 to server/computing device 102 and/or receive data outputs 120 from server/computing device 102. Such computing devices include, for example, one or more of desktop computers, laptops, mobile computing devices (e.g., PDAs), server computers, and/or so on. In this implementation, the input data comprises, for example, data hierarchy, data files, due dates, and/or so on, for digital file association with system 100. In one implementation, the data outputs include, for example, a current valuation, future valuation, and/or so on. Embodiments of the present invention may also be used for collaborative projects with multiple users logging in and performing various operations on a data project from various locations. Embodiments of the present invention may be web-based.

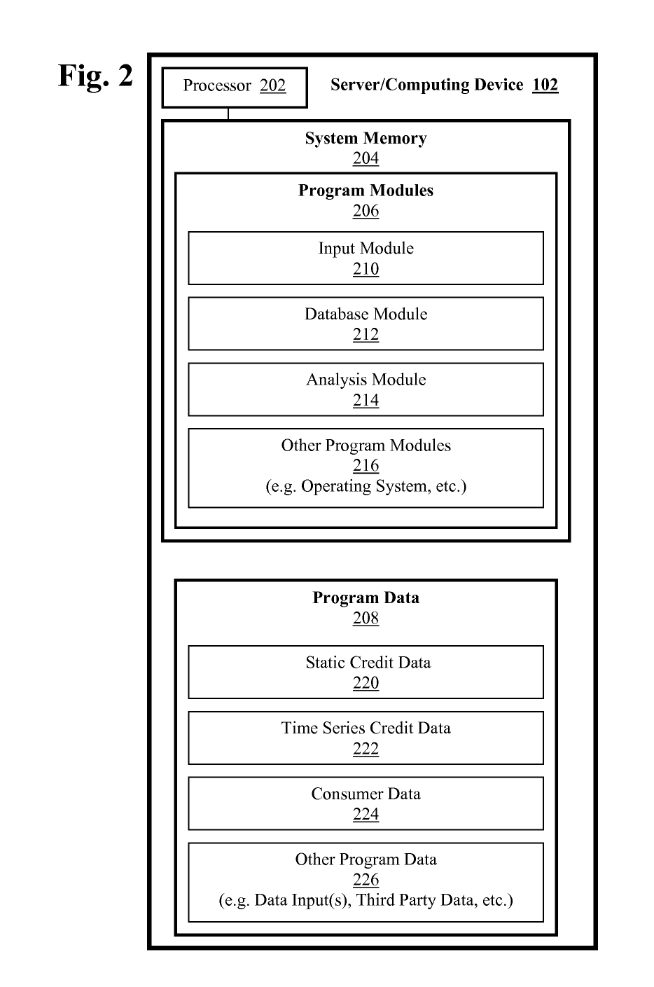

In this exemplary implementation, server/computing device 102 includes at least one processor 202 coupled to a system memory 204, as shown in FIG. 2. System memory 204 includes computer program modules 206 and program data 208. In this implementation program modules 206 may include input module 210, database module 212, analysis module 214, and other program modules 216 such as an operating system, device drivers, etc. Each program module 210 through 216 may include a respective set of computer-program instructions executable by processor(s) 202. This is one example of a set of program modules and other numbers and arrangements of program modules are contemplated as a function of the particular arbitrary design and/or architecture of server/computing device 102 and/or system 100 (FIG. 1). Additionally, although shown on a single server/computing device 102, the operations associated with respective computer-program instructions in the program modules 206 could be distributed across multiple computing devices. Program data 208 may include static credit data 220, time series credit data 222, consumer data 224, and other program data 226 such as data input(s), third party data, and/or so on.

Embodiments of the present invention may provide systems and methods for data quality and data metrics analysis. The systems and methods of the illustrative embodiments described herein pertain to the application of data metrics and data quality to improve the effectiveness of a credit score. There are several drawbacks to the methods currently used to compute an individual's credit score. Many of these issues may be addressed using data quality analysis and/or data quality metrics.

The following sections present some key data quality metrics and the mathematical definitions anticipated in the instant application. However, it should be appreciated that these formulae may by varied when applied to particular data.

Furthermore, note that the terms credit data, credit report data, tradelines, public records, etc. are used to describe various embodiments of the present invention. It is expected that the type and source of data may be interchangeable in various embodiments of the present invention depending on needs and availability.

Information Quality Metrics

Intrinsic

Accuracy

Measures how close the test data sequence S is to the ‘truth’ set. The truth set must be obtained from external means and cannot be derived from S.

Let τ:S→[0,1] be an oracle such that τ maps the elements of the sequence sᵢ∈S to the value 1 iff the value of sᵢ is correct and 0 otherwise. The set S is often produced through some measurement or data entry process. These processes are prone to errors. The truth function τ indicates whether a given sequence element is correct.

The accuracy A is defined as

$$A = \frac{1}{max ( \vert S \vert , τ ( S ) )} {\sum }_{{s}_{i} ∈ S} τ ( {s}_{i} )$$

Redundancy/Uniqueness

Redundancy measures the amount of duplicate data in a sequence as a percentage of the total amount of data present. The Uniqueness and Redundancy sum to 1.

Let S be a data sequence and let s̅ be a set whose elements are the elements of S. Redundancy and Uniqueness are

$$R = 1 - \frac{\vert \overline{S} \vert}{\vert S \vert}$$

$$U = \frac{\vert \overline{S} \vert}{\vert S \vert}$$

Both Redundancy and Uniqueness are on the range [0,1].

Velocity

Measures the rate of change of data over time. Data is often dynamic and changes over time. For example, we may have data specifying the current percent complete on a set of projects. The project managers will routinely update this data with the current values. Velocity measures how frequently the data changes.

There are two distinct ways that velocity may be computed. One method is to compute the rate at which the data is changing, while, the other is to compute the rate of change in the data.

1. Velocity as the Rate of Data Change

Let S(t) be a data sequence at time t and T(t)=S(t−tₒ) be a time shift of S. Let v:S×T→{0,1} be a map such that v=1 if sᵢ≠tᵢ and 0 otherwise.

$$v = \frac{1}{Δ t} {\sum }_{i = 1}^{ma x ( \vert S ( t ) , S ( t + Δ t ) \vert )} v ( {s}_{i} ( t ) , {s}_{i} ( t + Δ t ) )$$

2. Velocity as the Rate of Change in Value

Let S(t) be a data sequence at time t and T(t)=S(t−tₒ) be a time shift of S. Let the values of the data field of S be sᵢ∈R. Let v:S×T→R be a map such that

$${v}_{i} = \frac{{s}_{i} - {t}_{i}}{Δ t}$$

Velocity is measured on the range (−∞, ∞) and counts the number of fields changed per unit time.

Acceleration

Measures the rate of change of velocity over time.

Similar to velocity, there are two distinct ways that acceleration may be measured. In both cases, the acceleration is the rate of change of velocity. As there are two different measurements of velocity, there are also two different measurements of acceleration. However, both accelerations may be computed using the same formula by applying the formula to each version of the velocity.

Let v(t) be the velocity measured at time t. The Acceleration is

$$a = \frac{v ( t + Δ t ) - v ( t )}{Δ t}$$

Acceleration is measured on the range (−∞, ∞).

Contextual

Completeness

Measures how many of the elements of the test data sequence S are present versus how many are left null (blank/no entry).

Let p:S→{0,1} be a map such that p takes the value 1 iff sₜ∈S is not null and 0 otherwise.

The completeness Cₚ for a set of parallel sequences S₁, S₂, . . . , Sₙ is defined as

$${C}_{P} = \frac{1}{n \vert S \vert} {\sum }_{{s}_{i} ∈ {S}_{1} , {S}_{2} , … , {S}_{n}} ρ ( {s}_{i} )$$

Amount of Data

Measures the relative amount of data present.

Let p be the number of data units provided and n be the number of data units needed. The Amount of Data D is

$$D = \frac{p}{d}$$

The Amount of Data is on the range [0, ∞). When D<1 there is always less data than needed. However, when D>1 there are more data units than needed, but this does not mean that we have all the data we need. For instance, we may have provided some redundant data and the amount of unique data present may be less than the data needed.

Timeliness

Measures the utility of data based on the age of the data. Data is often a measurement over some period of time and is valid for some period after. Over time, the utility of the data decreases as the true values will change while the measured data does not.

Let f be the expectation of the amount of time required to fulfill a data request r be the length of time the data is valid after delivery. The Timeliness T is given by

$$T = \frac{f}{v}$$

Coverage

Measures the amount of data present in relation to all data. Data is often a measurement of some type. For example, we may wish to list the names and addresses of everyone in a country. A give data set will have some of these, but likely will not have everyone.

Let π:S→N be an oracle that provides the length of the complete data sequence. Let τ:S→{0,1} be an oracle such that τ maps the elements of the sequence sᵢ∈S to the value 1 if the value of sᵢ is correct and 0 otherwise. The Coverage Cᵥ is

$${C}_{V} = \frac{1}{π ( S )} {\sum }_{{s}_{i} ∈ S} τ ( {s}_{i} )$$

The Coverage measures the amount of correct data in S in relation to the total amount of data in the true data sequence. Coverage is on the range [0,1].

Representational

Consistency

Consistency measures the number of rule failures in a data sequence as a proportion of all rule evaluations. Rules are often applied to data sequences. Some rules can be applies strictly to individual sequence elements (R:sᵢ<4∀sᵢ∈S) or may be defined across multiple sequences (R:sᵢ+tᵢ=1∀sᵢ∈S,tᵢ∈T,ST).

Given a rule R, we may compute all applications of R and determine whether the rule is satisfied (consistent) or is violated (inconsistent).

Let R be a sequence of applications of R. Let X:R→{0,1} be a map such that X takes the value 1 if the application rᵢ∈R is consistent and 0 otherwise.

The consistency Cₛ is given by

$${C}_{S} = \frac{1}{\vert R \vert} {\sum }_{{r}_{i} ∈ R} χ ( {r}_{i ,} )$$

Accessibility

Availability

Availability measures how often a data sequence is available for use. Databases may be unavailable at times for maintenance, failure, security breaches, etc. Availability measures the proportion of time a data sequence is available.

Let S be a data sequence. During some finite time t, let A be the amount of time S was available and U be the amount of time S was not available so that A+U=t. The Availability is

$${A}_{V} = \frac{A}{A + U} = \frac{A}{t}$$

The Availability is measured on the range [0,1].

Read Time

The Read Time measures how quickly data may be accessed from a sequence S. When a user requests to access a data sequence, there is a finite time required to gather the information and provide it to the user. The Read Time measures this delay.

The Read Time is the expectation of the time required to fulfill a data request from S.

The Read Time is measured on the range [0, ∞).

Write Time

The Write Time measures how quickly an update to a data sequence is available for use. When a user requests to update a data sequence, there is a finite time required to change the data and make the change available to others. The Write Time measures this delay.

The Write Time is the expectation of the time required to update a data sequence.

The Write Time is measured on the range [0, ∞).

Propagation Time

The Propagation Time measures how quickly an update to a data sequence may be used. Data is often dynamic. An update to a data sequence is only useful when it is available to other users.

Let w be the write time for a data sequence S and let r be the read time on S. The Propagation Time is

Tₚ=w+r

The Propagation Time is measured on the range [0, ∞).

Credit Scoring Issues

The current processes and data used in computing a credit score expose several data quality problems. The following sections describe some of these problems in relation to the data quality metrics impacted.

Timeliness

The accounts receivable information for each account is usually updated monthly at the CRAs. The date each CRA receives and updates this data on the credit report can be different. Credit grantors send their accounts receivable data at different times during the month to them. Some take 30 days to complete their billing cycle and send the data several times during the month. Each CRA updates this information on a different schedule also. This explains why one CRA will have a more current account update than another. It's also why credit reports are never the same across the three credit bureaus.

The timeliness metric measures how useful the current data. When an individual's credit data has a low value for timeliness, there is less confidence in the credit score. Alternatively, when the timeliness is high, the confidence in the credit score is higher. This reflects that concept that computing a credit score based on stale data may result in a credit score that does not reflect the individual's true credit worthiness.

Accounts are not updated at the same time: For example, a credit report at one of the CRAs shows a retail card updated in February 2011 and a mortgage updated in January 2011. These same accounts at another CRA could be both updated on February 2011.

Amount of Data

There is very little difference between the data collected by different CRAs. They basically collect the same information, but one may have a local credit union or bank contributing that another credit bureau doesn't get data from. For example, in January 2011, Experian announced the addition of positive apartment rental data to their credit file and will report negative rental data in 2012. This data is unique to them because of the purchase of a company, RentBureau that compiles rental information.

A thin credit report has very few accounts on it; therefore, it has very little credit history. The segments of the population to which this often applies are young adults, those new to the work force, students, new immigrants, widows, and divorcees. It is more challenging to evaluate their credit risk, because of the lack of credit history. Credit scores are built to evaluate thin reports and score them, although there is a special logic for evaluating them.

Another challenge those with thin files face is whether or not they'll even have a credit score. It's not a guaranteed thing, having a score. In order to receive a credit score, the credit report must meet the following criteria:

The file must have at least one account with activity in the past 6 months. This is based on the date it was reported on the credit report or the “date reported”.

The file must have at least one account opened for six months. The account has to be at least 6 months old. This is the “date opened” on the credit report.

The file cannot have a deceased indicator. The can occur if the account is shared with someone who has died or if the individual is dead.

One account can meet the qualifications for both items 1 and 2. The report can be scored with only one account as long as this account has been updated in the past 6 months and has been opened at least 6 months. An example of a thin credit report that cannot be scored is one that has one account opened three months ago.

A thick report contains numerous accounts, with some opened for many years. It contains a mixture of accounts such as revolving (credit cards), installment (mortgage and auto loans), opened and closed accounts. There is more than enough payment information, both current and historical to calculate a score and for creditors to make a credit decision.

The amount of data may be used to compute a confidence level on a credit score. Credit scores based on thick reports with numerous tradelines are likely to have a higher degree of accuracy than credit scores based on thin reports.

Completeness

Credit data is comprised of a set of tradelines. A tradeline is a database record that contains a set of data fields that contain information pertaining to an individual's credit worthiness.

Completeness of the data in a set of tradeline records is a data quality metric that may be used to indicate the quality of the credit data for a particular individual.

Below is a list of attributes of a tradeline, though not every tradeline may contain every item.

Account Name—This lists the name and address of the lender/creditor.

Account Number—A truncated or jumbled credit card or loan number.

Type of Account—There are four account types: revolving, open, installment, or mortgage. A revolving account is usually a retail card, bankcard, or gas card. If not paid in full, the amount owed revolves and is added to the debt outstanding the following month. Installment loans are accounts with a fixed amount each month for a specified time frame. Open accounts require payment in full each month. A mortgage is an installment loan so, same payment for some fixed period of time.

Account Owner/Responsibility—There are a variety of “responsibility” options: joint, authorized user, cosigner and individual. Joint is usually an account shared by a husband and wife; both are responsible for paying because both have “signed” for the loan. An authorized user is specific to credit cards. They authorized user has a card in their name but they are not liable for payments. A Cosigner is responsible for paying if the primary signee doesn't. And, an individual account means only one person is responsible for payments, except in the community property states.

Payment Status—The description of how debts are paid currently. The best is “pays as agreed.” It gets worse from there. The list and description of other ways to pay follows:

Pays as agreed

30 days late (30-59 days past due)

60 days late (60-89 days past due)

90 days late (90-119 days past due)

120 days late (120-149 days past due)

150 days late (159-179 days past due)

180 days late (180 days late and above)

Repossession

Charge off

Bankruptcy

Date Opened—The date the account was opened.

Date Reported—The last date the account was reported or updated on the credit report.

Date of Last Activity—The date there was activity on the account, which is a payment or billing.

Date Closed—The date the account was closed.

High Credit—The maximum amount ever owed, usually specific to credit cards.

Credit Limit—The maximum amount of credit approved or the loan amount or credit card.

Balance—The amount owed as of the date reported.

Terms—The monthly payment and number of months of the installment loan.

Months Reviewed—The number of months this account has been reported. which is the age of the current account. If it is closed it will be the age until it was closed.

Date of First Delinquency—The first date that an account was past due or at least 30 days late. This date is sometimes used as the “purge from” date.

Historical Payment Status—This is available for up to 7 years with the month and historical delinquency rating indicated. It can be displayed in a grid, with usually 24 months included. These are sometimes called “PHRs” (Previous High Rates) or “30/60/90 Buckets”, although it's the same as historical delinquency.

Completeness may be used as a factor when computing the confidence level for a particular individual's credit score. When the completeness metric is low, there are few tradelines that have complete information, and the credit score computed for the individual may be sensitive to the missing information. In this case, the confidence level for the credit score may be reduced relative to the confidence level associated with a similar individual with a high value of completeness.

Velocity/Acceleration

Credit scores are “real time”, meaning that just because the score was 700 today it doesn't mean that it will be 700 tomorrow. When a lender wants to obtain a credit report and get a score, they make the request to one of the credit bureaus, who then compiles the credit report, calculates the score and then delivers the information back to the requesting lender. Alternatively, the credit scores may be calculated by systems housed and maintained outside of a credit bureau. All of this happens in real time.

There is no mechanism whereby the score is “stored” by the credit bureaus and then re-used or redelivered at a later date. The next time a lender wants a credit report and score, the process takes place again with no memory or recollection of the previous score.

This process ignores the impact of the velocity and acceleration of the credit score. A consumer whose credit score is consistently rising is scored the same as a consumer whose credit score is consistently falling. The historical direction of the credit score may be used to further segment consumers to refine the predictability of the credit score.

Coverage

Credit scores are applied using the credit data, including, but not limited to tradelines and public record information, available to a particular CRA and determined by the CRA to belong to a particular consumer. However, any one CRA is unlikely to have the complete set of all available credit data or be able to compile all credit data reported from different lenders to the correct consumer.

Coverage measures the amount of tradelines available to a particular CRA in relation to the total tradelines available. When an individual's tradelines at a particular CRA has a high coverage, the resulting credit score will likely have a high degree of accuracy. When an individual's tradelines have a low coverage, there is many tradelines unavailable to the CRA, and the resulting credit score will have a low degree of accuracy.

Consistency

Tradelines are subject to consistency rules. For example, date opened should be prior to date closed. By computing the consistency metric for the tradelines for a particular individual, we discover any inconstancies within the set of tradelines.

When the consistency of a set of tradelines is high, the confidence in the resulting credit score is high. Alternatively, when the consistency metric is low, the confidence in the resulting credit score is lower. By computing the consistency metric for the tradelines for an individual, we may incorporate factors into the confidence of a credit score based on the consistency of the tradelines.

Availability

The availability metric may affect the confidence level for a credit score. If some of the tradelines for an individual's credit data are not available (a particular database is down for maintenance, hardware failure, etc.), or correctly linked to a consumer's credit report the resulting credit score will have a lower confidence that if all tradelines were available.

By computing the availability metric, the confidence level for a particular credit score may be adjusted in accordance with the availability metric.

Propagation Time

Any database has a finite propagate time for updating information. Measuring the propagation time helps to determine the likelihood that the current data is up-to-date.

When the propagation time is high, the resulting credit score may be incorrect due to updates that have not completely propagated through the database. Thus, when the propagation time is high, the confidence in the credit score is lower than when the propagation time is low.

Accuracy

A credit score computed based on inaccurate credit data does not reflect the true credit worthiness of the individual in question. Simple mistakes in the credit data or the assigning of tradelines to the wrong consumer can lead to significant changes in the computed credit score.

The accuracy metric may be used to compute the accuracy for a set of tradelines for an individual. When accuracy is low, there is little confidence in the resulting credit score. When accuracy is high, the degree of confidence in the credit score is higher.

Redundancy/Uniqueness

There is more confidence in a credit score based on a large number of tradelines (thick report) than a credit score based on a small number of tradelines (thin report). However, if many of the lines are simply repeats, or inaccurately assigned to a consumer's credit report then a thick report may actually be a thin report when considering only unique lines.

Computing the Redundancy/Uniqueness metric for an individual's tradelines, we can measure the true ‘thickness’ of the individual's credit report. This information may be used to compute the degree of confidence in the resulting credit score.

Application of Data Metrics to Credit Scoring

The previous section identified some problems with computing a credit score and how data quality metrics may affect the confidence of the resulting credit score. This section details methods for computing the confidence interval and the momentum for a credit score based on the computation of appropriate data metrics.

A credit score is computed based on a set of tradelines for an individual, where the tradelines represent the credit data available from a particular CRA at a particular instant in time. Each tradeline is a set of tradeline data fields (TDFs). The credit score is computed by applying a credit risk model to the tradelines for a particular individual (the individual may be a person, a company, or any entity that has tradeline information available).

The details of a credit risk model are not publically available. However, in many cases, the scoring weights for the model are available. For example, the FICO model has weights as Payment Performance (35%), Debt Usage (30%), Time in File (15%), Account Diversity (10%), and Search for Credit (10%). The exact model used to compute a score is not publicly available, but the scoring weights are publicly available.

Let [symbol] be the set tradelines for an individual whose credit score we desire to compute, and let [symbol] ᵢ∈ [symbol] be the tradeline in the set. Let [symbol] be the set of fields available for a given tradeline, and let [symbol] ᵢ∈ [symbol] be the j^{th} field. The data for a particular individual may be represented as a matrix Δᵢⱼ where the index i runs over the tradelines and the index i runs over the fields.

Let [symbol] be a credit model and let sₖ∈ [symbol] be the scoring weights (components) for the model. Each field fᵢ of a tradeline may map to one or more components of the scoring weight. Each tradeline field is associated with a vector \vec{w} where the components of the vector represent a weight of the field to the scoring component. Associating each tradeline field with such a vector results in a matrix wⱼₖ where the index j runs over the fields and the index k runs over the scoring components. The credit score is computed by applying the credit model to a particular set of tradelines. Let [symbol] be the credit score computed from the tradelines [symbol] .

The field weight matrix wⱼₖ may be fixed to a particular set of values, or this matrix may vary depending on the tradelines under consideration. In general, the field weight matrix is considered to be a function of the tradelines wⱼₖ( [symbol] ). For example, one weight matrix may apply to a set of tradelines for thin reports when | [symbol] |≦n, while a different weight matrix may apply to a set of tradelines for thick reports | [symbol] |>n, where is the thick-thin cutoff.

Let [symbol] be a set of data quality metrics to apply to [symbol] . We divide the data quality metrics into two sets: metrics computed on a single field on a single tradeline (filed-level), and metrics computed across fields or across tradelines (cross-field). For example, the accuracy metric is computed by summing over a set of data over the truth indicator τ(Δᵢⱼ). Each data field Δᵢⱼ individually may be accurate or inaccurate. This is a binary result:τ(x)=1 when x is accurate, and 0 when inaccurate. Functions that take on binary values such as this are called indicator functions.

Let qₗ∈ [symbol] be the value of a particular data quality metric. When qₗ is a field-level metric, application of data quality to the set of tradelines [symbol] examines individual data elements Δᵢⱼ. When qₗ is a cross-field metric, application of data quality to the set of tradelines [symbol] required examination of multiple data elements in order to compute a single data metric value. This difference is treaded using separate methods described below.

The following data quality metrics are filed-level metrics have the specified field-level indicators:

Accuracy—Indicated by the truth function τ(x) where τ(x)=1 when the field x is accurate and τ(x)=0 otherwise.

Field Velocity—Indicated by the data velocity function v(x) where v(x)=1 when the field x has changed from the last data snapshot and v(x)=0 otherwise. The field velocity may be considered a cross-field metric if the last data snapshot is considered a separate data set.

Field Acceleration—The field acceleration is not computed directly from a field indicator, but is computed from a single field (at two different moments in time). The field acceleration may be considered a cross-field metric if the last data snapshot is considered a separate data set.

Value Velocity—Value velocity is the measure of the change of a numerical field quantity over time. As this computation only requires the input from a single field, the value velocity is a single field metric. The value velocity may be considered a cross-field metric if the last data snapshot is considered a separate data set.

Value Acceleration—The value acceleration is computed from a single field (at two different moments in time). The value acceleration may be considered a cross-field metric if the last data snapshot is considered a separate data set.

Completeness—Indicated by the completeness function p(x) where p(x)=1 when the field x is complete (has non-null data present) and p(x)=0 otherwise.

Field Consistency—Indicated by the field consistency function y(x) where y(x)=1 when the field x is consistent and y(x)=0 otherwise. Consistency may be measured by a field indicator when the consistency rule depends only on the value of a single field. When the consistency rule depends on the value of multiple fields, then consistency is a cross-field metric.

Availability—Indicated by the field availability function a(x) where a(x)=1 when the field x is available and a(x)=0 otherwise.

Timeliness—Timeliness is indicated by the indicator function ζ(x) where ζ(x)=1 when the field x is timely and ζ(x)=0 otherwise.

Propagation Time—Indicated by the field propagation function x(x) where x(x)=1 when the field x has propagation time below a critical threshold and x(x)=0 otherwise.

Any data metric may be considered a cross-field metric when the metric is averaged over multiple fields. For example, accuracy metric as defined in the previous section is a cross-field metric because the overall accuracy is computed by summing the truth indicator across multiple fields.

The following data quality metrics are explicitly cross-field metrics:

Accuracy—Accuracy may be a cross-field metric when the truth function required input from multiple fields.

Redundancy/Uniqueness—Redundancy and uniqueness are cross-field metrics because they always require consideration of multiple fields (across separate tradelines) to compute the metric.

Amount of Data—The amount of data is generally the total number of tradelines | [symbol] |, but can also include information from public records, collection models, response, bankruptcy, etc. that are missing tradeline information. This generally requires multiple tradeline and fields to compute the metric.

Field Velocity—The field velocity may be considered a cross-field metric if the last data snapshot is considered a separate data set.

Field Acceleration—The field acceleration may be considered a cross-field metric if the last data snapshot is considered a separate data set.

Value Velocity—The value velocity may be considered a cross-field metric if the last data snapshot is considered a separate data set.

Value Acceleration—The value acceleration may be considered a cross-field metric if the last data snapshot is considered a separate data set.

Consistency—When the consistency rule depends on the value of multiple fields, then consistency is a cross-field metric.

Coverage—Coverage is the ratio of the amount of unique data present to the total amount of data available. This requires consideration of multiple tradelines and is generally a cross-field metric.

Different methods may be constructed using the definitions provided above. The next sections examine the case of field-level metrics, cross-field metrics, and methods combining field and cross-field metrics.

Field-Level Methods

When the metrics [symbol] are all field-level metrics, then each qₗ∈ [symbol] is computed from a single data field. This is represented as qₗ(Δᵢⱼ) which conveys the information that the data metric depends only on one particular filed value a particular tradeline.

A confidence interval is a minimum and maximum value [symbol] ₊ and [symbol] ₋ (confidence bounds) that represents the bounding range for a credit score [symbol] with a given level of statistical confidence and may include a specified time. Typically, [symbol] ₋≦ [symbol] ≦ [symbol] ₊. For example, we might say that a particular credit score of 700 has confidence interval [symbol] ₋=680, [symbol] ₊=750 where we are 95% confidence that the true credit score will lie in this range over the next 90 days.

Let \vec{λ}^{±} be a weight vector for the set of quality metrics where each component λₗ^{±} corresponds to a particular data metric qₗ. In this expression, λₗ^{±} indicates we have two separate values, λₗ⁺ and λₗ⁻. The confidence bounds are computed from the expressions

$${𝒞}_{+} = {\sum }_{i , j , k , l} {λ}_{l}^{+} {q}_{l} ( {Δ}_{ij} ) {}_{jk} ( ℐ ) {s}_{k}$$

$${𝒞}_{-} = {\sum }_{i , j , k , l} {λ}_{l}^{-} {q}_{l} ( {Δ}_{ij} ) {}_{jk} ( ℐ ) {s}_{k}$$

Alternatively, these expressions may be written as

$${𝒞}_{\pm } = {\sum }_{i , j , k , l} {λ}_{l}^{\pm } {q}_{l} ( {Δ}_{ij} ) {}_{jk} ( ℐ ) {s}_{k}$$

In this model, the quantities λₗ^{±} and wⱼₖ( [symbol] ) are model parameters that must be computed and provided to the model. The data quality metrics qₗ(Δᵢⱼ) are computed based on the tradeline data in question, and sₖ are the weight parameters for the credit risk model used to compute the credit score.

A momentum value may be computed similarly to the confidence bounds. Let [symbol] be the score momentum and let \vec{p} be a weight vector where each component pₗ corresponds to a particular data quality metric qₗ. The momentum value is computed as

$$ℬ = {\sum }_{i , j , k , l} {ρ}_{l} {q}_{l} ( {Δ}_{ij} ) {}_{jk} ( ℐ ) {s}_{k}$$

In fact, we may compute any number of different values incorporating data metrics into the credit score in a similar manner. Let [symbol] be a value of interest, and let be a weight vector where each component of the weight vₗ corresponds to a particular data metric qₗ. The value may be computed as

$$ℬ = {\sum }_{i , j , k , l} {v}_{l} {q}_{l} ( {Δ}_{ij} ) {}_{jk} ( ℐ ) {s}_{k}$$

Alternatively, these expressions may be written without the explicit dependence on the data values Δᵢⱼ. In this case, we simply replace Δᵢⱼ with the general tradeline set [symbol] and drop the explicit summation over i. Thus,

$$ℬ = {\sum }_{j , k , l} {v}_{l} {q}_{l} ( ℐ ) {}_{jk} ( ℐ ) {s}_{k}$$

Cross-Field Methods

When the metrics [symbol] are all cross-field metrics, then each qₗ∈ [symbol] is computed from a multiple data fields or using multiple tradelines. This is represented as ql( [symbol] ) which conveys the information that the data metric may depends on the entire set of tradelines under consideration.

Computing a value for cross-field metrics is similar to computing values for field-level metrics. Let [symbol] be a value of interest, and let \overline{\vec{v}} be a weight vector where each component of the weight v̅ₗ corresponds to a particular data metric qₗ, where the bar is used to distinguish these quantities from their field-level counterparts. The value may be computed as

$$\overline{ℬ} = {\sum }_{j , k , l} {\overline{v}}_{l} {\overline{q}}_{l} ( ℐ ) {\overline{}}_{jk} ( ℐ ) {s}_{k}$$

This expression is similar to the expression for field-level metrics. However, here the data quality metrics may depend on the entire set of tradelines rather than on a single element of a particular tradeline. This general formula may be applied to the confidence intervals

$${\overline{𝒞}}_{+} = {\sum }_{j , k , l} {\overline{λ}}_{l}^{+} {\overline{q}}_{l} ( ℐ ) {\overline{}}_{jk} ( ℐ ) {s}_{k}$$

$${\overline{𝒞}}_{-} = {\sum }_{j , k , l} {\overline{λ}}_{l}^{-} {\overline{q}}_{l} ( ℐ ) {\overline{}}_{jk} ( ℐ ) {s}_{k}$$

Similarly, the momentum is computed as

$$\overline{ℬ} = {\sum }_{j , k , l} {\overline{ρ}}_{l} {\overline{q}}_{l} ( {Δ}_{ij} ) {\overline{}}_{jk} ( ℐ ) {s}_{k}$$

It is often the case that the weight matrices w̅ⱼₖ are the same under both the field-level and cross-field models. In this case, the bar may be dropped from these quantities as w̅ⱼₖ=wⱼₖ.

Combined Methods

When the metrics [symbol] are a combination of field-level and cross-field metrics, then let qₘ∈ [symbol] represent the field-level metrics and let q̅ₙ∈ [symbol] represent the cross-field metrics. A value V may be computed by combining the field-level and cross-field methods.

The value V is computed as

$$V = {\sum }_{i , j , k , m} {v}_{m} {q}_{m} ( {Δ}_{ij} ) {}_{jk} ( ℐ ) {s}_{k} + {\sum }_{j , k , n} {\overline{v}}_{n} {\overline{q}}_{n} ( ℐ ) {\overline{}}_{jk} ( ℐ ) {s}_{k}$$

For the case of confidence intervals,

$${C}_{\pm } = {\sum }_{i , j , k , m} {λ}_{m}^{\pm } {q}_{m} ( {Δ}_{ij} ) {}_{jk} ( ℐ ) {s}_{k} + {\sum }_{j , k , n} {\overline{λ}}_{n}^{\pm } {\overline{q}}_{n} ( ℐ ) {\overline{}}_{jk} ( ℐ ) {s}_{k}$$

For the case of momentum,

$$M = {\sum }_{i , j , k , m} {ρ}_{m} {q}_{m} ( {Δ}_{ij} ) {}_{jk} ( ℐ ) {s}_{k} + {\sum }_{j , k , n} {\overline{ρ}}_{n} {\overline{q}}_{n} ( ℐ ) {\overline{}}_{jk} ( ℐ ) {s}_{k}$$

In these expressions, we have explicitly separated the field-level and cross-field metrics. However, if we use the field-level expressions without the explicit dependence on the data element Δᵢⱼ, the expressions take on similar forms:

$$V = {\sum }_{j , k , m} {v}_{m} {q}_{m} ( ℐ ) {}_{jk} ( ℐ ) {s}_{k} + {\sum }_{j , k , n} {\overline{v}}_{n} {\overline{q}}_{n} ( ℐ ) {\overline{}}_{jk} ( ℐ ) {s}_{k}$$

In the case where wⱼₖ= w̅ⱼₖ, these expressions may be combined into the single expression

$$V = {\sum }_{j , k , l} {v}_{l} {q}_{l} ( ℐ ) {}_{jk} ( ℐ ) {s}_{k}$$

where l runs over all values for both m and n.

Computing Model Parameters

The previous sections require the model parameters wⱼₖ and vₗ as inputs to the model. This section discloses methods to compute these model parameters. The model parameters may be computed by fitting the parameters using a large set of tradeline data, or the model parameters may be computed by estimating relative values.

Parameter Fit Method

If a set of tradeline data is available across multiple individuals, the model parameters may be fit by measuring the actual results of a value and then fitting the parameters using a least-squares or linear regression method.

For example, to fit the confidence interval over a time period, we would compute the value of the credit score at different points in time. At each point in time, the corresponding data metrics are computed.

For each individual in the set, compute the credit score at an initial point, then compute the credit score over the time intervals of interest. From this data, the distribution of credit scores over time may be computed. This distribution may depend on the initial credit score as well.

From the time-distribution of credit scores, a confidence interval may be computed at different confidence levels (the bounds for a 95% chance of the credit score over the time interval, the bounds for a 98% chance of the credit score of over the time interval, etc.). Again, these bounds may be distributed differently for different initial credit scores.

Once the upper and lower confidence bounds are known for a particular credit score, all individuals that have this credit score as their initial credit score are identified. For each of these individuals, the corresponding initial tradelines are identified. The data metrics are computed for each set of tradelines.

From this data, the model parameters are fit to the data using linear regression. This produces estimates for the model parameters λₗ^{±} and wⱼₖ( [symbol] ) (the latter is segmented if necessary so that wⱼₖ( [symbol] ) is the same for a given subset of tradelines in the fit).

As a more concrete example, suppose we are interested in two metrics, ‘Amount of Data’ and ‘Coverage’. Let [symbol] ᵢ(0) be the initial credit score of the i^{th} individual, and let [symbol] ᵢ(t) be the credit score for the i^{th} individual at time t. Furthermore, let aᵢ(0) and [symbol] ᵢ(0) be the ‘Amount of Data’ and ‘Coverage’ metrics respectively at the initial time, while [symbol] ᵢ(t) and [symbol] ᵢ(t) represent these metrics at time t.

Divide the data into two sets. The first set is the set of individuals where [symbol] ᵢ(t)≧ [symbol] ᵢ(0), while the second set is the set of individuals where [symbol] ᵢ(t)≦ [symbol] ᵢ(0). Under this division, a particular individual is in both sets if [symbol] ᵢ(t)= [symbol] ᵢ(0). Next, for each of these sets, remove the 5% of the most extreme values (values where | [symbol] ᵢ(t)− [symbol] ᵢ(0)| is largest). This reduces the set to the 95% of upper and lower confidence sets for the respective divisions.

For each set, we want to minimize the score

$${χ}^{2} = {\sum }_{i} {( {𝒞}_{i} ( t ) - {M}_{i} )}^{2}$$

where

Mᵢ=λ₁aᵢ(0)+λ₂cᵢ(0)

In this model, the weight parameters wⱼₖ( [symbol] ) and the scoring weights sₖ have been incorporated into the unknown parameters λ₁ and λ₂. Generally, this may always be done when computing the parameters. However, in many cases it is desirable to compute these to demonstrate the explicit relationships that the model parameters have with these weights.

Putting these expressions together,

$${χ}^{2} = {\sum }_{i} {( {𝒞}_{i} ( t ) - {λ}_{1} {a}_{i} ( 0 ) - {λ}_{2} {c}_{i} ( 0 ) )}^{2}$$

The model parameters are computed using the traditional least-squares techniques. Setting the partial derivatives to zero,

$$\frac{\partial {χ}^{2}}{\partial {λ}_{1}} = - 2 {\sum }_{i} {a}_{i} ( 0 ) ( {𝒞}_{i} ( t ) - {λ}_{1} {a}_{i} ( 0 ) - {λ}_{2} {c}_{1} ( 0 ) ) = 0$$

$$\frac{\partial {χ}^{2}}{\partial {λ}_{2}} = - 2 {\sum }_{i} {c}_{i} ( 0 ) ( {𝒞}_{i} ( t ) - {λ}_{1} {a}_{i} ( 0 ) - {λ}_{2} {c}_{i} ( 0 ) ) = 0$$

Let [xy] represent

$${\sum }_{i} {x}_{i} {y}_{i} .$$

Dropping the time dependence, these expressions become reduce to

[aᵢ [symbol] ᵢ]=λ₁[aᵢ²]+λ₂[aᵢcᵢ]

[cᵢ [symbol] ᵢ]=λ₁[aᵢcᵢ]+λ₂[cᵢ²]

These expressions may be solved for λ₁ and λ₂ using matrix methods. Thus, given in initial set of tradeline data, the upper and lower confidence bounds may be computed using linear regression techniques.

Similar techniques may be used to compute the momentum, or to extend the computations to more than two data quality metrics. Extending this to more than two metrics requires additional parameters for each additional metric desired. Moreover, extending this technique to other metrics requires the computation of the particular metric in question. For example, to fit for momentum, we replace [symbol] ᵢ(t) in the above expressions with [symbol] ᵢ(t)− [symbol] ᵢ(0).

Relative Value Method

The relative value method focuses on the weights rather than the fit parameters. Here, we begin with a quantity of interest V and estimate the relative impact of the various data quality metrics. For example, suppose the metrics under consideration are ‘Credit Score Velocity’ and ‘Account Opened Coverage’ and the value of interest is ‘Momentum’. The general expression for the momentum is given as

M=w₁vᵢ+w₂cᵢ

where the fit parameters and scoring weights have been incorporated into the weights. This is effectively the same expression as in the previous section. However, conceptually the focus is different. We expect a qualtity such as momentum is highly dependent on the credit score velocity and not as dependent on the coverage value for the ‘Account Opened’ field. From this we may explicitly weight these with a 100 to 1 ration and set

$$M = \frac{100}{101} {v}_{i} + \frac{1}{101} {c}_{i}$$

This method is less reliable than the parameter fit method. However, this method may be useful in cases where tradeline data is not available or is insufficient for accurate computations.

Combining Credit Scores

These techniques may be extended to cover multiple credit risk models. Let [symbol] ,be the credit score for the i^{th} credit model and let [symbol] ᵢ⁺ be the upper bound for the i^{th} model and let [symbol] ᵢ⁻ be the corresponding lower bound. The combined credit score is computed form the average as

$$𝒞 = \frac{1}{n} {\sum }_{i} {𝒞}_{i}$$

where n is the total number of credit risk models. The combined confidence interval is computed from propagation of errors as

$${( {𝒞}^{\pm } - 𝒞 )}^{2} = \frac{1}{n} {\sum }_{i} {( {𝒞}_{i}^{\pm } - {𝒞}_{i} )}^{2}$$

Reporting Confidence and Momentum

This section discloses a method for reporting confidence and momentum to an end user. The method translates scores for confidence and momentum to a separate graduated metrics and reports the results as a letter in combination with a momentum indicator.

Confidence bounds are translates to a letter system according to the ratio of the difference between the upper and lower confidence bounds to the underlying credit score. The table below provides an example of the confidence bound translation. Let

$$Γ = \frac{{𝒞}^{+} - {𝒞}^{-}}{𝒞} :$$

0≦Γ≦0.05→A

0.05<Γ≦0.1→B

0.10<Γ≦0.15→C

0.15<Γ≦0.25→D

0.25<Γ→F

Similarly, the momentum is graduated into five divisions. Let

$$P = \frac{𝒞 ( t ) - 𝒞 ( 0 )}{𝒞 ( 0 )} :$$

0≦P≦0.05→=

0.05<Γ≦0.1→+

0.1<Γ→++

0.05<−Γ≦0.1→−

0.1<−Γ→−−

This system produces results such as ‘A++’ meaning the underlying credit score has a high degree of confidence, and that the momentum indicates that the credit score is likely to move sharply up in the future. Alternatively, ‘C−’ means a moderate confidence in the credit score value and this value is likely to move down in the future.

System Using Data Metrics with Credit Scores

This section details a system for combining data metrics with credit scores.

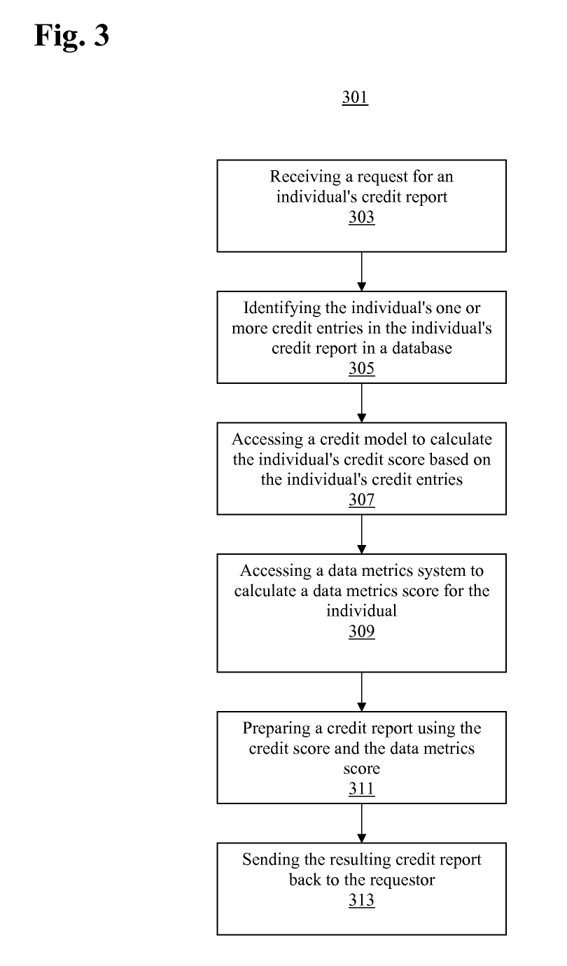

FIG. 3 illustrates an exemplary system and method that may be used for data quality and data metrics analysis 301. The system may use tradeline databases, one or more methods for computing credit scores, data quality metrics, and a reporting method to create a system that combines the results of data metric computations with the credit score. The system is applies to the set of tradelines for an individual when a credit score for the individual is requested.

In the preferred embodiment, a central server is used where the central server hosts a database of tradelines. The central server also hosts a data quality application where the data quality application is capable of computing data quality metrics for a given set of tradelines.

An external user makes a request for an individual's credit report 303. The request is routed to the central server where the request is interpreted by a credit report generator. The credit report generator is a software application capable of interpreting a request for an individual's credit report, identifying the individual's tradelines in the tradeline database 305, accessing a credit risk model to compute the individual's credit score based on the individual's tradelines 307, accessing a confidence/momentum system to obtain a confidence and/or momentum scores for the individual's tradelines 309, preparing the credit report 311, and sending the resulting credit report back to the external user 313.

The confidence/momentum system is a software based application that takes a set of tradelines as input. This system computes an upper and lower confidence bound based on the tradelines using data quality metrics as disclosed above. The system also computes the momentum of the credit score.

The confidence/momentum system also takes the credit score as input. From the confidence bounds and the momentum, the system computes a letter/sign score as described in the previous section. This score is produced as the output of the system to the credit report generator.

Enhanced Account Level Data Elements

Availability of account level data elements with a time series perspective may significantly impact the accuracy and reliability of CRA-based decision support solutions. One element of the enhanced data elements that may be used is monthly time series account level credit balance and limit information for all account types. This historical perspective about a consumer's credit obligations may provide lenders with a comprehensive view regarding velocity and consistency of a consumer's use and ability to repay credit obligations.

Anticipatory Credit Characteristics and Credit Scores

Inherently, credit characteristics and credit scores that involve credit bureau information are not static. Without any action taken by a consumer, the predictive value of credit information on a consumer's credit report changes as information ages or is deleted based upon federal regulations, causing a consumer's credit characteristics and credit scores to change. The ability to determine when a consumer's credit characteristics and credit scores will change, as well as the magnitude and direction, can significantly influence a wide variety of actions lenders can take to reduce account attrition within their portfolios and marketing offers towards consumers on the cusp of a different credit profile or credit score. Identifying the salient credit bureau based features that contribute differently over time to an individual's credit profile and credit score, understanding when these particular features reach a stage in an individual's credit report causing a change in either the credit profile or the points assigned to an individual's score or altering scorecard assignment, and determining the magnitude and direction of credit characteristics and credit score change may be utilized for anticipatory credit scores.

There are many factors that may be used to calculate anticipatory credit scores, and which have a positive or negative impact on credit score. The actual dates and timelines listed below are exemplary and subject to change. The factors may include, but are not limited to:

A. Derogatory public record and account performance
I. Chapter 7 Data—Must be removed after 120 months from dismissal/discharge
II. Chapter 13 Data—Must be removed after 84 months
III. Tradeline delinquency—Must be removed after 84 months from occurrence (31 days past due or worse)
   i) Charged off tradelines automatically drop off after 84 months
   ii) Closed tradelines with delinquency (historical) drop off after 84 months
   iii) Active accounts/open with historical derogatory information must be dropped off after 84 months
IV. Derogatory public records—Must be removed after 84 months from file date

B. Closed Accounts (last updated)—Accounts not updated within specified time as defined by the credit scoring system deployed might not be included in calculations

C. Aging of accounts—The number of active tradelines reaching certain age thresholds or the age of the oldest tradeline within a consumer's credit report, as specified within the credit scoring system deployed, is typically expressed in number of months since opened. As the average age of the tradeline reported on a consumer credit report or the age of the oldest tradeline increases the anticipatory credit score will change.

D. As delinquency or derogatory information contained on active and closed tradelines and collection accounts reach age thresholds, as specified by the credit scoring system deployed, scorecard assignment may change placing the consumer into a different risk segment and/or the number of points assigned to a consumer's credit score may increase, changing the consumer's credit score.

E. As public record information reach age thresholds, as specified by the credit scoring system deployed, scorecard assignment may change placing the consumer into a different risk segment and/or the number of points assigned to a consumer's credit score may increase, changing the consumer's credit score.

The systems and methods of the present invention may provide:

A) A process to determine the age of delinquent tradelines, collection accounts and derogatory public record information, used by the specified credit characteristic and credit scoring system, on a consumer's credit report.

The age of the delinquent tradelines, collection accounts and public record information may be used to determine when this information will either reach an age threshold, as defined within the specific credit characteristic or credit scoring system, or will be deleted from the consumer's credit report. The age of delinquent tradelines, collection accounts or public record information or the deletion of this information from the credit report may result in either a different credit characteristic profile or number of points assigned to various credit features and may change the scorecard used by the credit scoring system, whereby the consumer's credit score may change. Every delinquent tradeline, collection account and derogatory public record is evaluated to determine when the certain tradeline delinquency, collection account or derogatory public record items of occurred. The date when the tradeline delinquency, collection account or derogatory public record item of interest occurred is subtracted from the current date to determine number of months each item of interest has been reported on the consumer's credit report. The number of months each delinquent tradeline or collection item has been reported is then subtracted from 84 to determine how many months the oldest delinquent tradeline and collection account item will remain on the consumer's credit report. Depending upon the type of public record item, the number of months each item has been on the consumer's credit report the is subtracted from either 84 or 120 to determine the how many months the public record item will remain on the consumer credit report.

B) A process to determine the age of tradelines that do not contain delinquent information and credit inquires, used by the specified credit characteristic and credit scoring system, on a consumer's credit report.

The age of tradelines that do not contain delinquent information and credit inquiries used by a credit characteristic or credit scoring system may be used to determine when this information will either reach an age threshold, as defined within the specific credit characteristic and credit scoring system, or when credit inquiries will be deleted from the consumer's credit report. The age of tradelines without delinquent information and credit inquiries or the deletion of this information from the credit report may result in a different credit characteristic profile or number of points assigned to various credit features, and may change the scorecard used by the credit scoring system, whereby the consumer's credit score may change. When calculating the future age of every tradeline without delinquent information and credit inquiry the current age of each eligible item, as defined by the specified credit characteristic and credit scoring system, the age is increased by the number of months in the future that the consumer's credit characteristics and credit score will reflect. For example, if the future consumer's credit characteristics and credit score is to reflect what the credit profile and credit score will be five months in the future, the age of every tradeline without delinquent information and credit inquiry the current age of each eligible item, as defined by the specified credit characteristic and credit scoring system, is increased by 5 months. The future age of tradelines without delinquency and credit inquiries is used within the specified credit characteristic and credit scoring system(s) to determine which tradelines without delinquency and credit inquiries are eligible to be included within credit characteristics used by the specified credit characteristics and credit scoring system(s). The inclusion and exclusion of tradelines without delinquency and credit inquiries from various credit features within the specified credit characteristic and credit scoring system(s) may impact the number of points attributed to that credit characteristic, which may result in a different credit score.

C) A process that arbitrarily determines the future age of information used within the specified credit characteristics and credit scoring system(s) to calculate anticipatory credit score(s).

Users of anticipatory credit characteristics and credit scores may have various business reasons to understand what the anticipated credit characteristics and score(s) for specific individuals within a group of accountholders or credit prospects is at some specific point in time. In these situations, the user may input the number of months in the future that the anticipatory credit characteristics and score(s) need to reflect.

For delinquent tradelines, collection accounts and public record information the number of months the oldest delinquent tradeline, collection account and public record item(s) will remain on the consumer's credit report may be used to determine which items should be included as inputs for the specified credit scoring system(s). The number of months for each of the oldest delinquent tradeline, collection account and public record item(s), computed in process A) above, is compared to the number of months that the anticipatory credit characteristics and credit score(s) need to reflect. The oldest delinquent tradeline, collection account and public record item(s) with number of months remaining on a consumer's credit file equal to or less than the number of months in the future that the anticipatory credit characteristics and credit score(s) need to reflect may be used as inputs to the specified credit scoring system(s) to generate anticipated credit characteristics and credit score(s) desired.

For tradelines that do not contain delinquent information and credit inquiries, the current age of each eligible item, as defined by the specified credit scoring system, may be increase by the number of months in the future that the consumer's anticipatory credit characteristics and credit score(s) is desired to reflect.

D) A process that independently determines the future age of information used within the specified credit scoring system(s) to calculate anticipatory credit score(s).

Users of anticipatory credit characteristics and scores may have various business reasons to understand what the anticipated credit characteristics and score(s) for specific individuals within a group of accountholders or credit prospects and when the anticipatory credit characteristics may change. In these situations, the user may want the anticipatory credit score system(s) to inform the user what the anticipatory credit score(s) will be and when initial score change may occur.

For delinquent tradelines, collection accounts and public record information the number of months the oldest delinquent tradeline, collection account and public record item(s) will remain on the consumer's credit report may be one of the candidate factors used to determine the future age of information used within the specified credit scoring systems(s). Each of the oldest delinquent tradeline, collection account and public record item, computed in process A) above, on a consumers credit report having the item with the lowest number of months may be one of the factors used to determine the future age of information used to calculate anticipatory credit scores.

Another candidate factor used to determine the future age of information used to calculate a consumer's anticipatory credit scores may be derived from age thresholds associated with the various point values associated with credit features associated with tradelines that do not contain delinquent information and credit inquiries. For each credit feature within the credit scoring system(s) specified, the number of months used to determine various age thresholds that result in different point assignments may be identified. The number of months associated with each age threshold that result in assigning different points for all credit characteristics used by the credit scoring system(s) specified may be compared. The threshold with the fewest number of months to trigger a change in the number of points assigned to derive a consumer's credit score may be another candidate factor used to determine the future age of information used to calculate a consumer's anticipatory credit characteristics and credit score.

The oldest delinquent tradeline, collection account and public record item on a consumer's credit report with the lowest number months may be compared to the number of months for credit characteristics associated with tradelines that do not contain delinquent information and credit inquiries. The lowest number of months between the two values may determine the future age of information used to calculate a consumer's anticipatory credit score(s).

The value associated with the lowest number of months between the two values compared may be returned with the anticipatory credit and credit scores.

E) A process to communicate which credit characteristics within a given model contributed to the anticipated score.

Users of anticipatory credit scores may have various business reasons to understand which underlying credit features caused a change between a consumer's current credit score(s) and anticipatory credit score(s).

To identify the credit features that caused a change between a consumer's current credit score(s) and anticipatory credit score(s) the absolute value of each point value from the credit feature used to derive a consumer's current credit score may be subtracted from the absolute value of the corresponding point values used to calculate the anticipatory credit score. Credit features with absolute point value differences greater than zero are rank ordered from the highest value to the lowest value and the characteristic adverse reason code used by the specified credit scoring system may be returned with the anticipatory credit score.

Calculation of Approximate Historical Credit Characteristics and Scores from a Current Credit Report

Introduction of historical credit balance and credit limit information from credit bureaus in addition to their traditional credit report may provide additional information for analysis and processing. The addition of historical credit balance and credit limit information to a consumer's credit report may allow users to compute historical credit scores based upon information currently available on one's credit report. The ability to calculate a series of historical credit characteristics and scores from the current credit report provides users with the ability to better understand the magnitude and direction of a consumer's credit profile and score over time enabling them to better assess consumer credit risk over time. This additional information may allow users to modify a variety of actions to mitigate credit risk and other treatment strategies affecting account holder retention and profitability, as well as account acquisition strategies. Current Fair Credit Reporting legislation and rules imposed by the leading credit bureaus restrict credit characteristic and credit score users from taking action based upon historical credit characteristics and credit scores, which are currently obtained from a slow and costly approach of securing multiple archived consumer credit reports and processing them. With the ability to calculate a series of historical credit characteristics and credit scores from the consumer's current report credit users no longer need to rely upon credit reporting agencies to perform consumer credit report retrievals and processing to validate historical credit characteristic and credit score performance and users may now incorporate historical credit characteristics and credit scores, based on current credit reports, for improved account acquisition and management strategies. Approximate historical credit scores may be developed using the enhanced account level data elements. Knowledge about time series data may provide insight into, for example, credit scores at the time of loan origination.

The systems and methods of the present invention may provide:

A) A dating process that establishes the historical status of currently open and currently closed tradelines, collection accounts, derogatory public records and credit inquiries.

The ability to determine the historical status of currently open and closed tradelines collection accounts, derogatory public records and credit inquiries may establish which information was present on a consumer's credit report. This may also establish whether or not the historical status of that information qualified the tradeline, collection account, derogatory public record and credit inquiry to be included in the specified credit characteristic and scoring system(s).

To establish the historical status of currently open tradelines, collection accounts, derogatory public records and credit inquiries the current date of currently open tradelines, collection accounts, derogatory public records and credit inquiries used within the specified credit characteristic and credit scoring system(s) may be progressively reduced by one month for each historical monthly credit characteristic and credit score desired. When the historical age of currently open tradelines, collection accounts, derogatory public records and credit inquiries are older than the origination date of the tradeline, collection account, and derogatory public record and credit inquiry that specific tradeline, collection account, derogatory public record and credit inquiry may be ignored by the specified credit characteristic and credit scoring system(s).

To establish the historical status of currently closed tradelines and collection accounts, the current date of closed tradelines and collection accounts used within the specified credit scoring system(s) may be progressively increased by one month for each historical monthly score desired. When the historical age of currently closed tradelines and collection accounts are older than the origination date of the tradeline or collection account, it may then be treated as an open tradeline or collection account by the specified credit characteristic and credit scoring system(s). Then the same process described above may be used to establish the historical status of currently closed tradelines and collection accounts.

Once the historical status of currently open and currently closed tradelines, collection accounts, derogatory public records and credit inquiries are established all information associated with each tradeline, collection account, derogatory public record and credit inquiry available for each point in time of interest may be used by the specified credit characteristic and credit scoring system(s).

Calculation of Consumer Segment Credit Trends from a Current or Archived Credit Report

The availability of historical credit balance and credit limit information to a consumer's credit report provides users with the ability to generate a wide variety of consumer delinquency and credit use time series metrics based upon credit balance and credit availability without obtaining credit report information from multiple credit bureau archives. By obtaining samples of current credit reports of consumers of interest users of embodiments of the present invention can generate delinquency and credit use patterns for consumer credit segments of interest. Consumer credit segments may be based upon user specified credit characteristic and credit scoring systems and grouping consumer credit reports according to address, demographic and credit report information available from current consumer credit reports. Delinquency and credit use patterns may be derived from tradelines of interest by organizing and analyzing tradeline information for consumer segments of interest by calendar month. Comparison of delinquency and credit use time series patterns across consumer segments or coupled with macroeconomic and aggregate credit time series information may enable users to identify emerging credit trends and future credit conditions that allow users to make better lending and investment decisions.

Calculation of vintage/portfolio industry trends may be developed using the enhanced account level data elements. Knowledge about time series data may provide insight into industry trends from a single/current snapshot of credit information. Multiple accounts may be grouped together to show how groups change over time. Groupings may be selected based on one or more predetermined parameters. A suitable time frame may then be selected to optimize value from the resulting information. This may require standardization of account delinquency payment patterns for closed and open accounts. Trends may be calculated that show credit changes for the selected group over time.

The systems and methods of the present invention may provide:

A) A process to organize open and closed tradeline information by calendar month or other time period from a current or archived credit report.

Tradelines on a consumer credit reports have different origination and closed dates making it difficult to produce aggregate time series delinquency and credit use information from an individual's current consumer credit report or from current consumer credit reports. The current process to generate aggregate time series delinquency and credit use information either from an individual's current consumer credit report or from current consumer credit reports is to gather delinquency and credit use information by retrieving consumer credit reports of interest from periodic archives, calculating credit characteristics of interest for the credit reports identified, generating metrics from each archive and then combining metrics from each archive to create a time series. Embodiments of the present invention may replace the process described above, allowing users to independently generate time series delinquency and credit use time series in a faster and less costly manner.

To organize open and closed tradeline information by calendar month or other time period from a current or archived credit report tradelines from consumers within the consumer segment of interest are selected from either the unique lender reporting code, date of origination, current payment status, original loan amount, historical payment status, current balance, loan type, credit limit, account type or any combination derived from these tradeline features.

For open tradelines the date of last credit activity may be used to determine the most recent calendar month in which historical credit information is available. Historical time series credit information on a current credit report may be reported left to right with the most recent information in the left most position. Going from left to right, each subsequent data field for every historical time series element may then be assigned to the previous month from the month of last credit activity. The length of the historical time series for any credit element may be limited to the length of historical data fields provided by the credit reporting agency, typically 48 months.

For closed tradelines, the tradeline closed date is used to determine the most recent calendar month in which historical credit information is available. The same process described above to assign the month in which historical information is assigned may be used.

Credit Information assigned within each calendar month may then be converted into various metrics of interest to describe the tradeline delinquency and credit use performance for the consumer credit segment for each month within the time series.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A system for data metrics analysis, the system comprising:
at least one processor and at least one memory, wherein the at least one processor is adapted to perform one or more of the following steps:
receiving a request for an individual's credit report;
identifying the individual's one or more credit entries from the individual's credit report;
accessing a credit model;
calculating a credit score with the credit model using aspects derived from the individual's credit report;
accessing a data metrics model;
calculating a data metrics score for the individual's one or more credit entries;
preparing a credit report combining the results of the credit score and the data metrics score; and
sending the credit report.

2. The system of claim 1, wherein one or more credit entries are selected from the group consisting of delinquent tradelines, collection accounts and derogatory public record items.

3. The system of claim 1, wherein the data metrics model is a velocity model that computes a rate of change of data over time.

4. The system of claim 3, wherein the velocity model is computed as a rate of data change.

5. The system of claim 3, wherein the velocity model is computed as a rate of change in value.

6. The system of claim 1, wherein the data metrics model is an acceleration model that computes a change in velocity over time.

7. The system of claim 6, wherein the velocity is computed as a rate of data change.

8. The system of claim 6, wherein the velocity is computed as a rate of change in value.

9. The system of claim 1, wherein the data metrics model is a confidence/momentum model that computes an upper and lower confidence bound based on the individual's one or more tradelines using data quality metrics.

10. The system of claim 1, wherein the data metrics model is a confidence/momentum model that computes a momentum of the credit score.

11. The system of claim 1, wherein the data metrics model uses a field metrics calculation.

12. The system of claim 1, wherein the data metrics model uses a cross-field metrics calculation.

13. The system of claim 1, wherein the data metrics model uses a combined field and cross-field metrics calculation.

14. The system of claim 1, wherein the data metrics model uses a parameter metrics calculation.

15. The system of claim 1, wherein the data metrics model uses a relative value metrics calculation.
